(19) United States
(12) Patent Application Publication
(10) Pub. No.: US 2015/0268416 A1
(43) Pub. Date: Sep. 24, 2015

(54) SENSOR SYSTEM WITH OPTICAL SOURCE FOR POWER AND DATA

(71) Applicant: TYCO ELECTRONICS CORPORATION, Berwyn, PA (US)

(72) Inventor: Joseph C. COFFEY, Burnsville, MN (US)

(73) Assignee: TYCO ELECTRONICS CORPORATION, Berwyn, PA (US)

(21) Appl. No.: 14/219,871

(22) Filed: Mar. 19, 2014

(51) Int. Cl. G02B 6/10; G01D 11/00; G01D 7/00

(52) U.S. Cl. CPC G02B 6/10; G01D 7/00; G01D 11/00

(57) ABSTRACT

A system and method for sensing conditions in harsh environments. The system includes at least one sensor powered by an optical source. The optical source is coupled to the at least one sensor by an optical fiber. A data interface is coupled to the at least one sensor by the optical fiber. The optical fiber transmits data from the at least one sensor to the data interface and provides power from the optical source to the at least one sensor.

### FIELD OF THE INVENTION

This invention relates to a sensor system which uses an optical source for both power and data transmission. In particular, the system is directed to sensors which use power derived from fiber optic cables.

### BACKGROUND OF THE INVENTION

For years, people have used remote sensors in hostile environments, placing sensors in locations where human or manual data collection is unattainable or too costly. In toxic and environmentally dangerous environments, for example, remote sensors may provide an effective way of measuring data that might otherwise go unmeasured. In space-constrained environments, remote sensors may be useful in reaching otherwise unreachable locations.

Despite the deployment of remote sensors in certain applications, many applications are incompatible with certain types of remote sensors, or remote sensors altogether. Electrically-powered remote sensors, for example, are not used in environments where electrical conduction can lead to sensor damage or environmental damage. For example, high voltages could be hazardous if combined with electrically powered sensors in certain environments, such as oil wells and inside fuel tanks where there is the potential for an igniting hazard through short circuits in the electrical wiring.

Whereas electrically-powered sensors may be incompatible with certain environments, optically-powered sensors may show potential, as an optically powered sensor can protect against electric fields, discharges and other electronic interference.

Yet, despite the theoretical attractiveness of optically-powered sensors, there are numerous limitations affecting their deployment. One problem is the lack of efficient and effective methods to optically power multiple sensors. Some powering techniques convert an optical energy on a fiber to electrical power at the sensor. However, the techniques are only used to power a single sensor, unless a fiber optic splitter or multiplexing device is used, thereby adding to device cost, weight, and complexity. Furthermore, remote powering techniques can require a minimum of two fibers for each sensor—one fiber to optically power the sensor, another fiber to receive sensor data. In short, the present techniques for optically powering remote sensors would require multiple fibers or a large fiber bundle if multiple sensors were to be deployed, and this requirement is undesirable in many systems, including, but not limited to, those systems which are space- or weight-constrained.

While fiber optic sensors have been suggested for use in harsh or hazardous environments, fiber optic sensors currently make up a small number of the sensors that are currently used in such environments. Most such sensors output a non-optical signal, and the information sensed by these sensors is typically carried in the form of an electrical signal that is conveyed to a remote location over an electrical telemetry system. Thus, electrical telemetry systems for communicating with remote sensors are the norm in may such environments.

It would, therefore, be desirable to provide a system in which optically powered sensors could be more easily used in harsh or hazardous environments.

### SUMMARY OF THE INVENTION

An embodiment is directed to a system for sensing conditions in harsh environments. The system includes at least one sensor powered by an optical source. The optical source is coupled to the at least one sensor by an optical fiber. A data interface is coupled to the at least one sensor by the optical fiber. The optical fiber transmits data from the at least one sensor to the data interface and provides power from the optical source to the at least one sensor.

An embodiment is directed to a sensor system for sensing conditions in harsh environments. The sensor system includes at least one sensor which has a photoelectric element to convert light transmitted from an optical source through an optical fiber to power the at least one sensor. The optical source is coupled to the at least one sensor by the optical fiber. A data interface is coupled to the at least one sensor by the optical fiber. The data interface includes an optoelectrical device used to convert optical signals sent by the at least one sensor into electronic signals which can be transmitted by the data interface.

An embodiment is directed to a method of sensing conditions in harsh environments. The method includes: connecting a sensor to an optical fiber; positioning the sensor; supplying light to the sensor through the optical fiber; converting the light into power to operate the sensor; sensing the conditions; transmitting data from the sensor to a data interface through the optical fiber; converting the data into electronic signals; and transmitting the electronic signals.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic representation of an illustrative embodiment of a sensor system of the invention.

FIG. 2 is a schematic representation of a first alternate illustrative embodiment of a sensor system of the invention.

FIG. 3 is a schematic representation of a second alternate illustrative embodiment of a sensor system of the invention.

FIG. 4 is a diagram of an illustrative method of the inventions.

### DETAILED DESCRIPTION OF THE INVENTION

The description of illustrative embodiments according to the principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the illustrative embodiments. Accordingly, the invention expressly should not be limited to such illustrative embodiments illustrating some possible non-limiting combination of features that may exist alone or in other combinations of features; the scope of the invention being defined by the claims appended hereto.

The illustrative embodiments are directed to a system 10 for sensing conditions in various environments. In particular, the embodiments are directed to a system 10 which can be used in harsh or hazardous environments 11, such as, but not limited to, mines, gas pipelines and oil drill heads. The sensor system 10 uses fiber optic cable or optical fiber to transfer data from the sensors to a data interface. The system 10 also provides power to the sensors via the optical fiber, thereby eliminating the need for power to be delivered via a known electrical power source delivered by known electrical wires.

The sensor system 10 includes one or more sensors 12, 14 coupled to an optical source 16 and a data interface 18 by an optical fiber 20. In general, the optical source 16 provides power to the sensors 12, 14 via the optical fiber 20. The optical fiber 20 also carries data generated by the sensors 12, 14 to the data interface 18. In the embodiment shown, the optical source 16 and the data interface 18 are provided in one device. However, in other embodiments, the optical source 16 and the data interface 18 may be provided in separate devices.

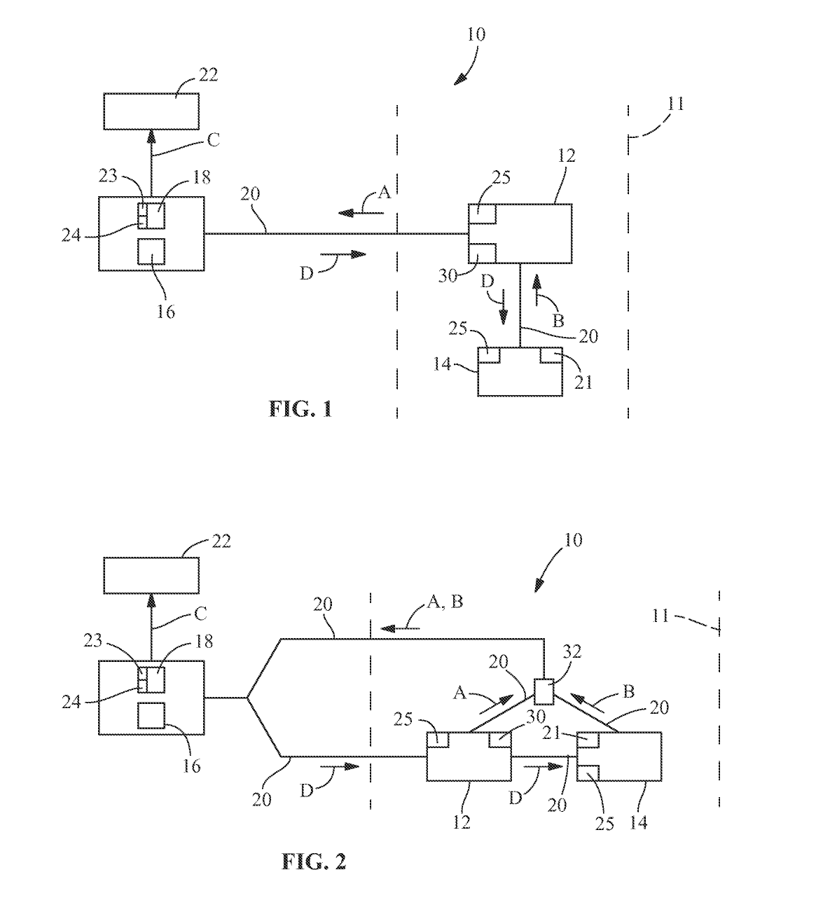

Referring to the illustrative embodiment shown in FIG. 1, the sensor system 10 includes an optical sensor 12 and a non-optical sensor 14. Both sensors 12, 14 are coupled to the optical fiber 20. In this embodiment, the optical sensor 12 outputs a first optical signal A that is coupled with the optical fiber 20. The first optical signal is transmitted by the optical fiber 20 to the data interface 18. The non-optical sensor 14 outputs a second optical signal B. Alternatively, the non-optical sensor 14 outputs a non-optical signal, such as an electrical signal, a magnetic signal, or an acoustic signal. Such non-optical signal is converted into a second optical signal by a converter 21. The second optical signal of the non-optical sensor 14 is also coupled with the optical fiber 20. The second optical signal is transmitted by the optical fiber 20 to the data interface 18. The type of converter used depends on the type of signal outputted from the non-optical sensor. For example, for electrical signals, the converter includes an electro-optic device, such as a light emitting diode (LED), which converts electrical signals into intensity modulations in the light output of the LED. The optical output of the LED is coupled onto and transmitted over the optical fiber. In another example, the converter may incorporate an intrinsic fiber optic sensor, such as those described above, to convert a non-optical signal into an optical signal.

While the embodiment shown discloses an optical sensor 12 and a non-optical sensor 14, the system 10 may include one or more optical sensors 12, one or more non-optical sensors 14, or any combination thereof.

The optical signals are transmitted through the optical fiber 20 to the data interface 18 for processing. In the embodiment shown, the data interface 18 is provided in a remote location away from the sensors 12, 14. This allows the sensors 12, 14 to be placed in hazardous environments while allowing the data interface 18 to be placed in a more environmentally friendly and/or more accessible environment, as will be more fully described below. Similarly the optical source 16 is also placed in a more environmentally friendly and/or more accessible environment.

The data interface 18 receives the signals generated by the sensors 12, 14 via the optical fiber 20. The data interface 18 detects the signals, decodes or demodulates the signals, and provides output C for an operator to use. The data interface includes processing equipment to decode the signals and provide useable output. The processing equipment will typically include an optoelectronic device 23, such as, but not limited to, a photodiode, photoemissive detector, photo-multiplier tube, or the like, to convert the optical signals into electrical signals that can be processed using standard processing electronics. In the exemplary embodiments shown in FIGS. 1 and 2, the output generated by the data interface 18 is converted to a wireless signal which can be transmitted to a mobile device 22 or another location. Devices 24 for converting the output into wireless signals are known in the art. Such devices, include, but are not limited to, a transmitter which receives the output, converts it to a pulse width modulated signal and transmits it wirelessly to the one or more wireless receivers, including, but not limited to mobile devices.

As previously stated, the optical source 16, such as, but not limited to a laser, incandescent or discharge lamp, light emitting diode (LED), or the like, may also be located within the same device as the data interface 18. Alternatively, the optical source 16 may be located elsewhere. Additionally, more than one optical source 16 may be optically coupled with the optical fiber 20. The optical source 16 provides light via the optical fiber 20 to the optical sensor 12 and, in some embodiments, also to a non-optical sensor 14.

A variety of optical sensors may be used in the invention. These include both intrinsic fiber optic sensors and extrinsic fiber optic sensors.

Intrinsic fiber optic sensors can be used as sensors to measure strain, temperature, pressure and other quantities by modifying a fiber so that the quantity to be measured modulates the intensity, phase, polarization, wavelength or transit time of light in the fiber. Sensors that vary the intensity of light are the simplest, since only a simple source and detector are required. A feature of intrinsic fiber optic sensors is that they can, if required, provide distributed sensing over very large distances. Examples of intrinsic fiber optic sensors, include, but are not limited to, sensors using Bragg grating; sensors based on total internal reflection for measuring, for example, vibration, pressure, or index of refraction changes; etalon-based fiber optic sensors for measuring strain, pressure, temperature, or refractive index; and interferometric fiber optic sensors for measuring strain, acoustics, vibrations, rotation, or electric or magnetic fields.

Extrinsic fiber optic sensors use an optical fiber cable, normally a multimode cable, to transmit modulated light from either a non-fiber optical sensor, or an electronic sensor connected to an optical transmitter. A benefit of extrinsic sensors is their ability to reach places which are otherwise inaccessible. Extrinsic fiber optic sensors include, but are not limited to, intensity-based fiber optic sensors for measuring, for example, linear or rotary position; and fiber optic sensors for spectroscopic measurements (absorption or fluorescence), such as for chemical sensing or for measuring temperature, viscosity, humidity, pH, etc.

Non-optical sensors, include, but are not limited to, pressure and temperature sensors, video cameras, geophones, which convert seismic vibrations into electrical signals, acoustic or sonic wave sensors, and sensors based on micro-electro-mechanical systems (MEMS) and micro-optoelectro-mechanical systems (MOEMS).

The sensors 12, 14 are powered by the optical transmission D, such as light, received from the optical source 16. In the exemplary embodiment, a photovoltaic or photoelectric element 25 is provided to convert the light being transmitted from the optical source 16 through the optical fiber 20 into sufficient electrical power to operate the sensor 12, 14. Devices other than photoelectric elements may be used without departing from the scope of the invention. This allows the sensors 12, 14 to be placed in hazardous environments without the need for electrical wiring or the like.

A single optical fiber, which generally has greater data bandwidth capacity than electrical cables, can support multiple optical signals using one or more of a variety of multiplexing techniques. For example, a modulation or multiplexing device 32 (FIG. 2) may use wavelength division multiplexing to allow a plurality of optical signals, each at a different wavelength of light, to be transmitted simultaneously over an optical fiber. Another multiplexing technique, time division multiplexing, uses different time intervals, e.g., varying pulse duration, pulse amplitude and/or time delays, to couple multiple signals onto the optical fiber. Still another multiplexing technique, wavelength division multiplexing, uses a different wavelength for each optical signal, allowing the multiplexed sensor signals to be differentiated based on their wavelengths. Other multiplexing techniques known in the art, such as coherence, polarization, and spatial multiplexing, may also be used to couple multiple optical signals onto a single optical fiber. The multiplexed signals may be demodulated using techniques known in the art.

In many applications the sensors 12, 14 must be sealed to protect the sensors 12, 14 from exposure to the environments in which they are positioned. In order for the sensors 12, 14 to properly operate, light transmitted by the optical source 16 over the optic fiber 20 must be received by the sensor 12, 14 and converted to power. In the exemplary embodiment, a photovoltaic or photoelectric element 24 is provided to convert the light being transmitted through the optical fiber into sufficient electrical power to operate the sensor 12, 14 and allow the sensor 12, 14 to transmit the data back over the optical fiber 20. Devices other than photoelectric elements may be used without departing from the scope of the invention.

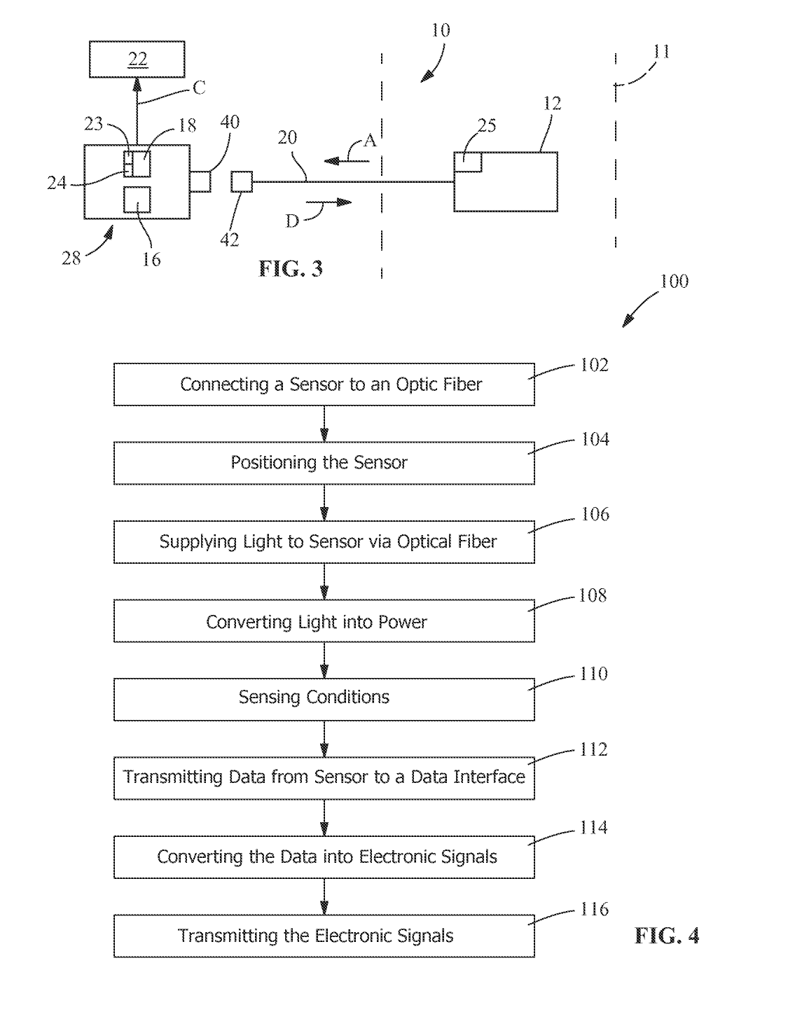

Referring to FIG. 3, an alternate illustrative embodiment is shown. In this embodiment, the optical source 16 and data interface 18 are provided in device 28 which is connected to a sensor 12 by means of an optical fiber 20. Although an optical sensor is shown, the optical sensor may be replaced by a non-optical sensor without departing from the scope of the invention.

As the device 28 interacts with only one sensor 12, 14, the device 28 needs only be large enough to house a small optical source 16, such as, but not limited to laser pointer or other similar source. The optical source 16 can be any source which generates sufficient light to power the sensor 12, 14. As the device 28 can be positioned proximate the sensor 12, 14, the length of the optical fiber 20 can be configured to minimize the results of attenuation or transmission loss.

The device 28 of FIG. 3 can be a mobile, portable and/or hand-held unit which can be connected and disconnected from the optical fiber 20 as required. In order to allow for ease of connection, the device 28 has a connector 40 which mates and unmates with a mating connector 42 provided at an end of the optical fiber 20. This allows an operator to obtain field readings from the various sensors 12, 14. The device 28 is powered by battery or other mobile powering device, thereby eliminating the need to have a local power source available.

As previously described, the data interface 18 receives the signals generated by the sensors 12, 14 via the optical fiber 20. The data interface 18 detects the signals, decodes or demodulates the signals, and provides output for an operator to use. The data interface includes processing equipment to decode the signals and provide useable output. The processing equipment will typically include an optoelectronic device, such as, but not limited to, a photodiode, photoemissive detector, photo-multiplier tube, or the like, to convert the optical signals into electrical signals that can be processed using standard processing electronics. In the exemplary embodiment shown in FIG. 3, the output generated by the data interface 18 is converted to a wireless signal which can be transmitted to a mobile device 22 or another location. Devices 24 for converting the output into wireless signals are known in the art. Such devices, include, but are not limited to, a transmitter which receives the output, converts it to a pulse width modulated signal and transmits it wirelessly to the one or more wireless receivers, including, but not limited to mobile devices.

In various illustrative embodiments, the sensor 12, 14 may also include a low level optical source 30 which is used to transmit data to the data interface 18 via the optical fiber 20. Such data is modulated on the optical fiber 20.

In the exemplary embodiment, a photovoltaic or photoelectric element 25 is provided to convert the light D being transmitted from the optical source 16 through the optical fiber 20 into sufficient electrical power to operate the sensor 12, 14 and the optical source 30 to transmit the data back over the optical fiber 20. Devices other than photoelectric elements may be used without departing from the scope of the invention.

In general, referring to FIG. 4, the method 100 of sensing and transmitting the data sensed by the sensor or sensors includes connecting 102 a sensor 12, 14 to the optical fiber 20 and positioning 104 the sensor 12, 14 in the proper position. An optical source provides optical input 106, such as light, to the sensor 12, 14 through the optical fiber 20. The optical input is converted 108 into power to operate the sensor 12, 14, allowing the sensor 12, 14 to sense 110 the conditions. The data collected by the sensor 12, 14 is then transmitted 112 from the sensor 12, 14 to the data interface 18 through the optical fiber 20 and is converted 114 into electronic signals. The electronic signals are then transmitted 116 as needed.

The system, as illustrated in the illustrative embodiments without fear of igniting gases or the like through short circuits in electrical wiring, as the sensor system 10 uses fiber optic cable or optical fiber to transfer data from the sensors to a data interface and supply power to the sensors. Consequently, the system 10 eliminates the need for a local power to be delivered via a known electrical power source delivered by known electrical wires. The system can also be used for one or more sensors, with the length of the fiber optic cable being only limited by the attenuation or transmission loss. The sensors can also be used with a portable hand-held data interface and optical source.

While the invention has been described with reference to an illustrative embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A system for sensing conditions in harsh environments, the system comprising:
at least one sensor powered by an optical source;
the optical source coupled to the at least one sensor by an optical fiber;
a data interface coupled to the at least one sensor by the optical fiber;
the optical fiber transmits data from the at least one sensor to the data interface and provides power from the optical source to the at least one sensor.

2. The system as recited in claim 1, wherein the optical source and data interface are housed in a portable unit which can be connected and disconnected to the optical fiber as needed.

3. The system as recited in claim 2, wherein the portable unit is powered by battery.

4. The system as recited in claim 3, wherein the portable unit is a hand-held unit.

5. The system as recited in claim 1, wherein a photoelectric element is provided in the at least one sensor to convert light transmitted from the optical source through the optical fiber to power the at least one sensor.

6. The system as recited in claim 1, wherein the data interface includes an optoelectrical device used to convert optical signals sent by the at least one sensor into electronic signals which can be transmitted by the data interface.

7. The system as recited in claim 1, wherein the data interface includes an optoelectrical device used to convert optical signals sent by the at least one sensor into wireless electronic signals which can be transmitted by the data interface to a mobile device.

8. The system as recited in claim 1, wherein the at least one sensor is at least one optical sensor.

9. The system as recited in claim 1, wherein the at least one sensor is at least one non-optical sensor.

10. The system as recited in claim 9, wherein a converter converts the data generated by the at least one non-optical sensor into an optical signal which is transmitted vie the optical fiber to the data interface.

11. The system as recited in claim 1, wherein the at least one sensor is at least one optical sensor and at least one non-optical sensor.

12. The system as recited in claim 1, wherein the at least one sensor is an intrinsic fiber optic sensor.

13. The system as recited in claim 1, wherein the at least one sensor is an extrinsic sensor.

14. The system as recited in claim 1, wherein the at least one sensor is sealed.

15. A sensor system for sensing conditions in harsh environments, the sensor system comprising:
at least one sensor having a photoelectric element to convert light transmitted from an optical source through an optical fiber to power the at least one sensor;
the optical source coupled to the at least one sensor by the optical fiber;
a data interface coupled to the at least one sensor by the optical fiber, the data interface includes an optoelectrical device used to convert optical signals sent by the at least one sensor into electronic signals which can be transmitted by the data interface.

16. The system as recited in claim 15, wherein the optical source and data interface are housed in a portable unit which can be connected and disconnected to the optical fiber as needed.

17. The system as recited in claim 15, wherein the electronic signals are wireless electronic signals which can be transmitted by the data interface to a mobile device.

18. The system as recited in claim 15, wherein the at least one sensor includes at least one optical sensor.

19. The system as recited in claim 1, wherein the at least one sensor includes at least one non-optical sensor.

20. A method of sensing conditions in harsh environments, the method comprising:
connecting a sensor to an optical fiber;
positioning the sensor;
supplying light to the sensor through the optical fiber;
converting the light into power to operate the sensor;
sensing the conditions;
transmitting data from the sensor to a data interface through the optical fiber;
converting the data into electronic signals;
transmitting the electronic signals.
